(19) United States
(12) Patent Application Publication
(10) Pub. No.: US 2022/0176282 A1
(43) Pub. Date: Jun. 9, 2022

(54) FILTER ASSEMBLY

(71) Applicant: 3M INNOVATIVE PROPERTIES COMPANY, St. Paul, MN (US)

(72) Inventors: Hannah L. Stoughton, Afton, MN (US); Windy A. Santa Cruz, Minneapolis, MN (US); Matthew W. Gorrell, South St. Paul, MN (US); John B. Stender, St. Paul, MN (US); Tommie W. Kelley, Shoreview, MN (US); Christine L. McCool, St. Paul, MN (US); Stephen M. Sanocki, Stillwater, MN (US); Yaohua Gao, Woodbury, MN (US); Joseph A. Dunbar, Woodbury, MN (US); John M. Brandner, St. Paul, MN (US)

(21) Appl. No.: 17/441,478

(22) PCT Filed: Mar. 18, 2020
(86) PCT No.: PCT/IB2020/052488

§ 371 Date: Sep. 21, 2021

Related U.S. Application Data
(60) Provisional application No. 62/823,449, filed on Mar. 25, 2019.

(51) Int. Cl. B01D 39/16; B01D 39/20; B01D 46/00

(52) U.S. Cl. CPC B01D 39/1623; B01D 39/2082; B01D 39/1615; B01D 2239/0478; B01D 39/2027; B01D 46/0005; B01D 2239/0457; B01D 39/2017

(57) ABSTRACT

Filter assemblies are described. In particular, filter assemblies that include a filter frame, a fire resistant filter media, and a metallic layer disposed on and covering a major surface of the filter frame are described. The filter frame is rigid and includes at least one of a polymeric material, wood, or a wood pulp material. Filter assemblies described include flammable or meltable materials yet may retain structural integrity after being exposed to flame.

### BACKGROUND

Filters are used for many purposes; for example, removing small suspended particulates from the air. Filter assemblies may include both a rigid frame and a filter media.

### SUMMARY

In one aspect, the present description relates to a filter assembly. The filter assembly includes a filter frame, a fire resistant filter media web secured to and bordered by the filter frame, and a metallic layer disposed on and covering a major surface of the filter frame, having a face disposed in a plane parallel to the plane of the filter media web. The metallic layer includes at least 200 nm of metal on the major surface father from the filter frame. The filter frame is rigid and includes at least one of a polymeric material, wood, or a wood pulp material.

### BRIEF DESCRIPTION OF THE DRAWINGS

FIG. 1 is a top plan view of a filter assembly.

FIG. 2 is a rear perspective view of a filter assembly.

FIG. 3 is a schematic side elevation cross-section of a filter assembly.

### DETAILED DESCRIPTION

Filter assemblies can be used in a wide range of applications. Filter assemblies can be used to install or fix a filter media in a particular location. Filter assemblies that include a frame and filter media may include handles, hooks, tabs, or other mechanical or adhesive components that can attach, store, or secure the filter assembly in its intended position. In some embodiments, these filter assemblies can fit in or be secured in a filter cage (which may alternatively or additionally have appropriate mechanisms to secure the filter assembly in place). In some embodiments, the filter assembly may be configured for general air filtering purposes; for example, in a room air filtering system, a furnace filtering system, or another forced air filter system. In these embodiments, the filter frame and filter media are configured such that the filter primarily filters airborne particulates. For example, the filter media may be designed to filter particles smaller than 10 micrometers in diameter, smaller than 5 micrometers in diameter, 2.5 micrometers, or 0.3 micrometers in diameter. In some embodiments, the filter assembly may be used for a specialized purpose, such as in a commercial kitchen, for grease filtering purposes.

In commercial kitchens, grease capture in exhaust hoods may be important for health, safety, and environmental reasons. Grease buildup in and around an exhaust hood or the ducting in airflow communication with the exhaust hood may pose a fire hazard, the grease deposits being highly flammable. Exacerbating the danger, commercial exhaust hoods are configured to accommodate a large volume of air traveling through them, which can magnify the hazard should a fire start.

To mitigate the hazard, commercial kitchens typically use airflow interrupters or disrupters, such as a baffle, made of a non-flammable material, such as a metal or metal alloy like stainless steel, galvanized steel, or aluminum. The baffle prevents fire from spreading between the cooking surface and the ductwork above. Additionally, aerosolized grease travels through the complicated path created by the baffle and condenses on the surfaces, preventing grease accumulating further up in the ducts. However, this grease buildup on the baffle requires regular cleaning; otherwise, the baffle's effectiveness as both a fire barrier and a grease collector is reduced. Aesthetically, visible grease on a commercial hood baffle can also be unattractive or unappetizing in a modern open kitchen. Unfortunately, baffles cannot be cleaned in place and are heavy—often weighing several kilograms. Removing, cleaning, and reinstalling the baffles can be time consuming, labor-intensive, and dangerous.

Filter assemblies as described herein may allow for effective filtration of grease droplets generated from commercial cooking processes, while enabling a disposable or semi-reusable filter change process. Such filter assemblies may include lightweight components but still enable configurations that retard or resist flames from a commercial cooking area traveling into or through an exhaust hood.

Non-meltable (at typical normal and kitchen fire temperatures), fire-resistant, and flame-retardant materials are excellent choices for filters and filter assemblies. However, such materials can be expensive, heavy, and complicated to manufacture. Surprisingly, configurations described herein incorporate otherwise meltable or flammable materials—that are inexpensive or straightforward to manufacture—yet still demonstrate fire-resistant properties: in particular, maintaining structural integrity when subjected to high-heat flames.

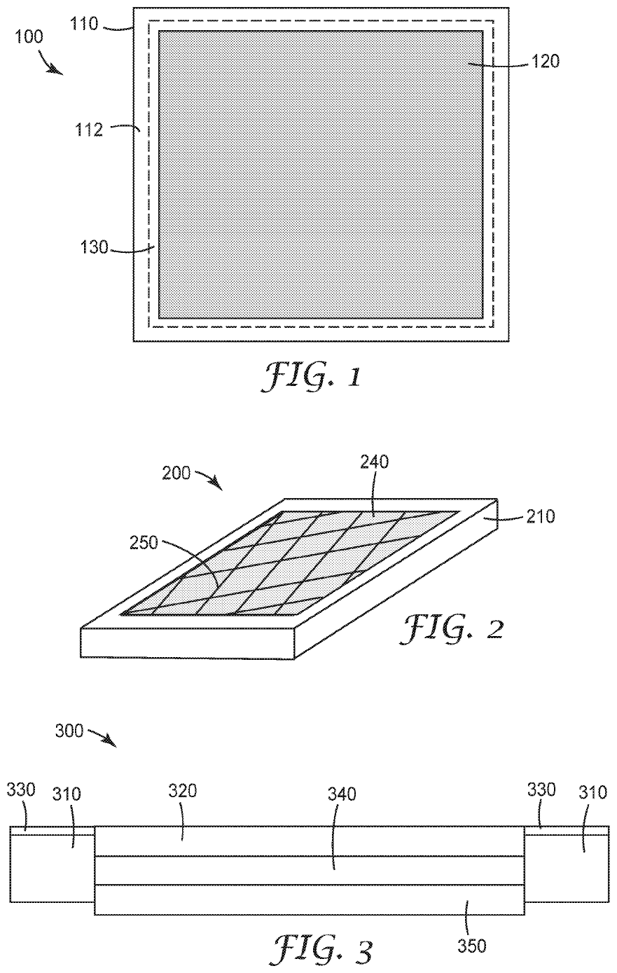

FIG. 1 is a top plan view of a filter assembly. Filter assembly 100 includes filter frame 110 with major surface 112, fire resistant filter media web 120, and metallic layer 130 disposed on the major surface of the filter frame.

Filter frame 110 may be any suitable size and may be formed from any suitable material. In some embodiments, filter frame 110 may have a substantially rectangular frame shape, as depicted in FIG. 1. In some embodiments, filter frame 110 is rigid. Filter frame 110 may be formed from or may include a polymeric material, or may be formed from or include a wood or a wood pulp material. Polymeric materials may be injection moldable or compatible with an additive manufacturing process. Lightweight woods such as a balsa wood or cork wood, may be used. Manufactured wood products such as particleboard, fiberboard, or chipboard may be particularly appropriate. In some embodiments, wood pulp materials such as cardboard, paperboard, and the like may be used. In some embodiments, carbon fiber, fiberglass, or composite materials may be used. Length, width, and thickness may be selected based on the desired application, to provide a suitable fit or a range of standardized sizes, to minimize the weight of the overall filter assembly, or to provide appropriate rigidity or structural stability.

A fire resistant filter media web 120 is secured to and bordered by filter frame 110. Fire resistant filter media web 120 may be any suitable filter media. In some embodiments, the fire resistant filter media web may be either a woven or non-woven web. Fire resistant filter media web 120 fibers may be or include oxidized polyacrylonitrile (OPAN), FR rayon, modacrylic, basalt, fiberglass, wool, or ceramic. In some embodiments, fire resistant filter media web 120 may be or include a metal mesh. In some embodiments, fire resistant filter media web 120 may be or include a conventional filter media material, treated or coated to be fire resistant. Any of the fire resistant filter media webs may be pleated, or non-pleated, or multilayered, depending on the desired application and performance.

Filter frame may have curved facets or flat facets. In some embodiments, filter frame 110 has a major surface 112 substantially in a plane parallel to a plane of the filter media web. In some embodiments, the major surface 112 is on the front surface; i.e., the surface of the filter frame designed to be installed facing toward the commercial cooking surface.

Disposed on major surface 112 is metallic layer 130. Metallic layer includes at least 200 nm of metal on the surface farthest from major surface 112. In some embodiments, the minimum thickness of metal on the metallic layer is required to provide sufficient protective or heat conductive functionality. Metallic layer 130 may be any metal or metallized layer, including a metal foil, sheet metal, metal mesh, rolled metal, metallized polymeric layers, sputter coated or vapor deposited metal on a substrate, an electroplated or electrodeposited metal (or metals) on a substrate, a metal screen, or perforated metal. In some embodiments, metallic layer 130 overhangs or extends beyond filter frame 110, as shown in FIG. 1. In some embodiments, from a top plan view, the filter frame is not exposed; i.e., it is covered by metallic layer 130.

In some embodiments, metallic layer 130 is secured to major surface 112 by aid of an adhesive. In some embodiments, the adhesive should be structurally stable up to the highest temperatures the filter assembly is exposed to in normal operation, to avoid melting or dripping onto food surfaces. In some applications, this may be 150° F., 200° F., or even higher. In some embodiments, the adhesive should be structurally stable up to 100° C. The adhesive may be applied separately from the metallic layer, or the metallic layer may already be coated with adhesive, such as with a foil tape.

In some embodiments, the metallic layer is a metal fascia or grill. Such a structure may snap onto or physically connect to the filter frame. Such attachment may be designed to be easily reversible (i.e., snap-on, snap-off) or to be permanent or semi-permanent. Suitable mechanisms may be included on the filter frame or the metal fascia in order to facilitate the desired physical connection.

Metallic layer 130 is disposed on at least major surface 112, but may have any suitable three-dimensional shape. In some embodiments, metallic layer 130 is substantially planar. In some embodiments, metallic layer 130 is bent or shaped to conform around and cover more than one surface of filter frame 110. In some embodiments, metallic layer 130 completely covers filter frame 110. In some embodiments, metallic layer 130 includes curved facets. In some embodiments, metallic layer 130 may be disposed on major surface 112, but may be spaced away from major surface 112, either by the shape of metallic layer 130 or by a physical spacer disposed between the metallic layer and the filter frame.

FIG. 2 is a rear perspective view of a filter assembly. Filter assembly 200 includes filter frame 210, polyolefin filter 240, and backing layer 250. Filter assembly 200 illustrates a possible configuration of combining multiple filter media layers in a single filter assembly. Polyolefin filters are commonly used in home furnace and air filter applications and may filter out tiny particulates, such as grease droplets, but may melt when exposed to flame. Therefore, such filters are not appropriate for use as a fire barrier. However, in combination with a fire resistant filter media web, a filter assembly can maintain its structural integrity when exposed to flames, and still benefit from the use of the polyolefin filter during standard operation conditions. In the optional configuration shown in FIG. 2, polyolefin filter 240 may be pleated or non-pleated, and may include multiple layers of filter media. Polyolefin filter 240 is secured to and bordered by filter frame 210, and is disposed farther than the fire resistant filter media web from the major surface of the filter frame. Note that, from the viewpoint of FIG. 2, neither the fire resistant filter media web nor the major surface of the filter frame is visible.

Backing layer 250 may be used in the optional configuration of FIG. 2 to provide additional structural stability to filter assembly 200. Backing layer 250 is secured to and bordered by filter frame 210 and can be any suitable layer, including a cardboard grid, a scrim, a fiberglass layer, or an expanded metal layer. Typically, backing layer 250 is configured to support the filter assembly without blocking airflow through the filter. The physical dimensions of backing layer 250 may be selected to provide structure without creating too severe of a pressure drop when installed and in use.

FIG. 3 is a schematic side elevation cross-section of a filter assembly. Filter assembly 300 includes filter frame 310, fire resistant filter media web 320, metallic layer 330 disposed on the major surface of the filter frame, polyolefin filter 340, and backing layer 350. FIG. 3 illustrates a possible configuration of a filter assembly. From the perspective of FIG. 3, the configuration of optional layers is more easily appreciated. Polyolefin filter 340 is disposed farther than fire resistant filter media web 320 from the major surface of filter frame 310. Backing layer 350 is disposed farther than fire resistant filter media web (and farther than polyolefin filter) from the major surface of filter frame 310. Other combinations are possible, including additional polyolefin filter, or backing layers, or, in some embodiments, without a polyolefin filter or without a backing layer.

### EXAMPLES

Embodiments of the present invention can be better understood by reference to the following example which is offered by way of illustration. The present invention is not limited to the example given.

TABLE 1
Materials.

| Item | Component | Description |
|---|---|---|
| OPAN FR | Fiber 1 | Oxidized polyacrylonitrile (OPAN) staple fiber with a denier |
| (fire resistant) | | diameter of 5 dtex × 60 mm and density of 1.37 g/cm³, |
| Media | | commercially available under the trade designation ZOLTEK |
| | | OX from ZOLTEK CORP., Bridgeton, Mo., USA. |
| | Binding fiber | High temperature polyester melty fiber with a denier |
| | | diameter of 6.7 dtex × 60 mm and density of 1.33-1.38 g/cm³, |
| | | commercially available under the trade designation |
| | | TREVIRA T270 from TREVIRA GMBH, Hattersheim, |
| | | Germany. |
| Filter | | 3M FILTRETE HEALTHY LIVING 1550 FILTER, |
| | | available from 3M Co., St. Paul, Minn. |
| FR Tape | | 3M FOIL TAPE 425, rated for use to 300° F. available from |
| | | 3M Co., St. Paul, Minn. |

### Example 1

### Preparation of Nonwovens

A representative working example airlaid nonwoven web was prepared including a blend of 90% Fiber 1 and 10% Binding fiber by weight. The web was formed using a conventional air-laying web forming machine (available from the Rando Machine Company, Macedon, N.Y., under the trade designation “RANDO WEBBER”), targeting a nominal area weight in the range of 100 grams per square meter (gsm). The collected fibers as formed in the RANDO-WEBBER apparatus were supported on a porous belt and then collected on a 3″ core by winding. The thickness of the output web was estimated to be in the range of approximately 10-20 mm.

The collected fibers as formed in the RANDO-WEBBER apparatus were supported on a porous belt and passed through a heating apparatus in which hot air (set at 160° C. (320° F.)) was drawn through the thickness of the collected fibers from air-side to belt-side (i.e., top to bottom). The belt speed was 1.82 m/min (6 feet/min). This resulted in sufficient fiber-fiber melt bonding that the resultant web was a self-supporting web that could be removed from the belt and subjected to further processing as described below.

### Construction of the Filter Assembly

The prepared OPAN filter was cut to 20″×20″ and placed on the face of the 3M 1550 filter. The edges were covered with the 3M Foil Tape 425. The foil tape extended 1.5″ on the face of the filter assembly along the edge of both faces. This held the OPAN filter media to the face of the furnace filter and completely covered the cardboard frame around the furnace filter.

### Testing of the Web Fire-Resistant Properties

The prepared filter construction from Example 1 was tested for fire-resistant properties in a vertical orientation using a furnace with propane burners. The furnace was heated to at least 350° F. prior to testing. Samples were mounted vertically onto the furnace over a 10×10″ opening such that the fire resistant layer (e.g. OPAN) was facing in towards the flames. Two burners (40,000 BTU per burner) were ignited for 3 minutes. Internal furnace temperatures increased from 350° F. to approximately 1000° F. The furnace was then cooled to 350-380° F. before the start of another test. Filters that pass this test remain intact and flames do not penetrate the sample, meaning the fire-stop layer acts as a barrier to the flame and is not burned or physically deteriorated during the test duration. Filters that fail the test have flame penetrate the sample, burn, or deteriorate such that holes appear in the fire stop layer.

While some discoloration after exposure to the flames was observed and the 3M 1550 filter melted away (but did not drip), the filter assembly from Example 1 passed the fire test, as the filter assembly remained intact and flames did not penetrate the sample.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

1. A filter assembly, comprising:
a filter frame;
a fire resistant filter media web secured to and bordered by the filter frame;
a metallic layer disposed on and covering a major surface of the filter frame, having a face disposed in a plane parallel to the plane of the filter media web;
wherein the metallic layer includes at least 200 nm of metal on the major surface farther from the filter frame;
wherein the filter frame is rigid and includes at least one of a polymeric material, wood, or a wood pulp material.

2. The filter assembly of claim 1, wherein the filter media web includes oxidized polyacrylonitrile fibers.

3. The filter assembly of claim 1, wherein the filter media web includes flame-retardant rayon.

4. The filter assembly of claim 1, wherein the filter media web includes basalt fibers.

5. The filter assembly of claim 1, wherein the filter media web includes wool.

6. The filter assembly of claim 1, wherein the filter media web includes a flame-retardant-treated material or a material coated with a flame-retardant coating.

7. The filter assembly of claim 1, wherein the filter media web includes at least one of: fiberglass, ceramic fibers, metal mesh, and modacrylic fibers.

8-10. (canceled)

11. The filter assembly of claim 1, wherein the metallic layer includes at least one of: a metal foil layer, a metallized film layer, vapor deposited metal, sputter coated metal, a metal fascia, a metal mesh, a metal screen, a perforated metal layer, and sheet metal.

12-19. (canceled)

20. The filter assembly of claim 1, wherein the filter frame includes at least one of: cardboard, paperboard, wood, fiberglass, carbon fiber, a composite material, an injection moldable plastic, and additive manufacturable plastic.

21-26. (canceled)

27. The filter assembly of claim 1, wherein the metallic layer is non-planar, and covers at least two faces of the filter frame.

28. The filter assembly of claim 1, wherein the metallic layer is attached to the filter frame by an adhesive.

29. The filter assembly of claim 28, wherein the adhesive is not grease soluble.

30. The filter assembly of claim 28, wherein the adhesive is structurally stable at 100 degrees Celsius.

31. The filter assembly of claim 1, wherein the metallic layer is planar, and extends beyond the major surface of the filter frame.

32. The filter assembly of claim 1, further comprising a second filter media web, disposed adjacent to the filter media web but further than the filter media web from the major surface of the filter frame, secured to and bordered by the filter frame, and including a polyolefin.

33. The filter assembly of claim 1, further comprising a fiberglass layer, secured to and bordered by the filter frame, and further than the filter media web from the major surface of the filter frame.

34. The filter assembly of claim 1, further comprising at least one scrim layer, secured to and bordered by the filter frame, and further than the filter media web from the major surface of the filter frame.

35. The filter assembly of claim 1, further comprising a cardboard grid layer, secured to and bordered by the filter frame, and further than the filter media web from the major surface of the filter frame.

36. The filter assembly of claim 1, further comprising an expanded metal layer, secured to and bordered by the filter frame, and further than the filter media web from the major surface of the filter frame.

37. The filter assembly of claim 1, wherein, from a top plan view, none of the filter frame is exposed.
